(19) United States
(12) Patent Application Publication
(10) Pub. No.: US 2025/0163260 A1
(43) Pub. Date: May 22, 2025

(54) LOW-DIELECTRIC RESIN COMPOSITION

(71) Applicant: NAN YA PLASTICS CORPORATION, TAIPEI (TW)

(72) Inventors: TE-CHAO LIAO, TAIPEI (TW); LI-YUN CHEN, TAIPEI (TW); WEI-RU HUANG, TAIPEI (TW); HUNG-YI CHANG, TAIPEI (TW); CHIA-LIN LIU, TAIPEI (TW)

(21) Appl. No.: 18/417,073

(22) Filed: Jan. 19, 2024

(30) Foreign Application Priority Data
Nov. 16, 2023 (TW) 112144178

(51) Int. Cl. C08L 63/00

(52) U.S. Cl. CPC C08L 63/00; C08L 2203/20; C08L 2205/025; C08L 2205/03

(57) ABSTRACT

A low-dielectric resin composition includes an epoxy resin, an active ester compound, a modified polyphenylene ether resin, and an inorganic filler material. Based on a total weight of the low-dielectric resin composition being 100 wt %, a content of the epoxy resin ranges from 5 wt % to 30 wt %, a content of the active ester compound ranges from 5 wt % to 40 wt %, a content of the modified polyphenylene ether resin ranges from 0.1 wt % to 20 wt %, and a content of the inorganic filler material is not less than 40 wt %. A ratio of the content of the active ester compound relative to the content of the epoxy resin ranges from 0.5 to 2.

### CROSS-REFERENCE TO RELATED PATENT APPLICATION

This application claims the benefit of priority to Taiwan Patent Application No. 112144178, filed on Nov. 16, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resin composition, and more particularly to a low-dielectric resin composition, which is suitable for being used as a build-up material for an IC substrate.

### BACKGROUND OF THE DISCLOSURE

In recent years, with the rapid development of integrated circuits (IC) and the design of high-speed computing chips, specifications have increased requirements for IC substrates in related electronic products. For example, higher wiring density and faster transmission rates are required for IC substrates. Accordingly, there is a trend towards developing build-up materials for the IC substrates with lower dielectric properties. Conventional build-up materials have relatively high dielectric losses, which are not conducive to the applications requiring high frequency and high-speed data transmission.

### SUMMARY OF THE DISCLOSURE

In response to the above-referenced technical inadequacy, the present disclosure provides a low-dielectric resin composition.

In one aspect, the present disclosure provides a low-dielectric resin composition that includes an epoxy resin, an active ester compound, a modified polyphenylene ether resin, and an inorganic filler material. Based on a total weight of the low-dielectric resin composition being 100 wt %, a content of the epoxy resin ranges from 5 wt % to 30 wt %, a content of the active ester compound ranges from 5 wt % to 40 wt %, a content of the modified polyphenylene ether resin ranges from 0.1 wt % to 20 wt %, and a content of the inorganic filler material is not less than 40 wt %. In addition, a ratio of the content of the active ester compound relative to the content of the epoxy resin ranges from 0.5 to 2.

In certain embodiments, the ratio of the content of the active ester compound relative to the content of the epoxy resin ranges from 0.65 to 1.8.

In certain embodiments, the inorganic filler material is spherical silica particles.

In certain embodiments, a surface of each of the spherical silica particles is modified with at least one of an epoxy group, an acrylic group, and a vinyl group, and a silica purity in each of the spherical silica particles is not less than 95 wt %. An average particle diameter D50 of the spherical silica particles ranges from 0.05 micrometers to 5 micrometers, and a specific surface area of each of the spherical silica particles ranges from 1 m²/g to 10 m²/g.

In certain embodiments, the low-dielectric resin composition further includes: a siloxane coupling agent, an accelerant, and a peroxide. Based on the total weight of the low-dielectric resin composition being 100 wt %, a content of the siloxane coupling agent ranges from 0.01 wt % to 5 wt %, a content of the accelerant ranges from 0.01 wt % to 5 wt %, and a content of the peroxide ranges from 0.005 wt % to 3 wt %.

In certain embodiments, the accelerant is an amine-based hardening accelerant.

In certain embodiments, the accelerant is selected from the group consisting of triethylamine, tributylamine, 4-dimethylaminopyridine (DMAP), 2,4,6-tris(dimethyl aminomethyl) phenol, 1,8-diazabicyclo[5.4.0]undec-7-ene (DBU), and 1,5-diazabicyclo[4.3.0]non-5-ene (DBN).

In certain embodiments, the epoxy resin is a mixed resin that includes a naphthol-novolac epoxy resin and a bisphenol F-type epoxy resin, and the naphthol-novolac epoxy resin and the bisphenol F-type epoxy resin are mixed with each other in a weight ratio of 1:2 to 2:1. In addition, the active ester compound has a naphthalene structure.

In certain embodiments, the modified polyphenylene ether resin is selected from the group consisting of a vinyl benzyl-containing polyphenylene ether resin, a methacrylate-containing polyphenylene ether resin, a vinyl benzyl-containing bisphenol A polyphenylene ether resin, and a chain-extended vinyl-containing polyphenylene ether resin.

In certain embodiments, a resin made of the low-dielectric resin composition has a dielectric constant (Dk) ranging from 3.0 to 3.3 and a dissipation factor (Df) of not greater than 0.0045 under a signal of 10 GHz.

In another one aspect, the present disclosure provides a low-dielectric resin composition that includes an epoxy resin, an active ester compound, an acrylic resin, and an inorganic filler material. Based on a total weight of the low-dielectric resin composition being 100 wt %, a content of the epoxy resin ranges from 5 wt % to 30 wt %, a content of the active ester compound ranges from 5 wt % to 40 wt %, a content of the acrylic resin ranges from 0.1 wt % to 20 wt %, and a content of the inorganic filler material is not less than 40 wt %. In addition, a ratio of the content of the active ester compound relative to the content of the epoxy resin ranges from 0.5 to 2.

In certain embodiments, the acrylic resin is selected from the group consisting of a methacrylate-containing polyphenylene ether resin, a dioxolane diol diacrylate resin, and a tricyclodecane dimethanol diacrylate resin.

Therefore, in the low-dielectric resin composition provided by the present disclosure, by virtue of “the resin composition including an epoxy resin, an active ester compound, a modified polyphenylene ether resin, and an inorganic filler material,” and “based on a total weight of the low-dielectric resin composition being 100 wt %, a content of the epoxy resin ranging from 5 wt % to 30 wt %, a content of the active ester compound ranging from 5 wt % to 40 wt %, a content of the modified polyphenylene ether resin ranging from 0.1 wt % to 20 wt %, and a content of the inorganic filler material being not less than 40 wt %,” and “a ratio of the content of the active ester compound relative to the content of the epoxy resin ranging from 0.5 to 2,” a resin made of the resin composition can have good dielectric properties (e.g., a Df value of not greater than 0.0045) and dimensional stability, which is beneficial to applications of high-frequency and high-speed transmission.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Low-Dielectric Resin Composition

Since conventional build-up materials used in IC substrates have relatively high dielectric constant, the conventional build-up materials are not conducive to applications requiring high frequency and high-speed data transmission.

In response to the above-referenced technical inadequacy, the present disclosure provides a low-dielectric resin composition, which can be used as a build-up material for an IC substrate to meet design requirements of high-frequency and high-speed computing chips.

To achieve the aforementioned objective, the low-dielectric resin composition at least includes an epoxy resin (A), an active ester compound (B), a modified polyphenylene ether resin (C), and an inorganic filler material (D).

The components (A) to (D) are all non-volatile components. That is, the components (A) to (D) are solid components, which do not evaporate during a drying process.

Furthermore, based on a total weight of the low-dielectric resin composition being 100 wt % (or based on a total weight of the non-volatile components in the resin composition being 100 wt %), a content of the epoxy resin (A) ranges from 5 wt % to 30 wt %, a content of the active ester compound (B) ranges from 5 wt % to 40 wt %, a content of the modified polyphenylene ether resin (C) ranges from 0.1 wt % to 20 wt %, and a content of the inorganic filler material (D) is not less than 40 wt %.

More specifically, the content of the epoxy resin (A) ranges from 10 wt % to 20 wt %, the content of the active ester compound (B) ranges from 10 wt % to 30 wt %, the content of the modified polyphenylene ether resin (C) ranges from 0.1 wt % to 10 wt %, and the content of the inorganic filler material (D) is not less than 50 wt % (e.g., ranging from 60 wt % to 90 wt %), but the present disclosure is not limited thereto.

In a preferred embodiment of the present disclosure, a ratio of the content of the active ester compound (B) relative to (divided by) the content of the epoxy resin (A) ranges from 0.5 to 2, preferably ranges from 0.65 to 1.8, and more preferably ranges from 0.8 to 1.5.

It is worth mentioning that the ratio of the content of the active ester compound (B) relative to the content of the epoxy resin (A) defined above (i.e., ranging from 0.5 to 2, preferably ranging from 0.65 to 1.8, and more preferably ranging from 0.8 to 1.5) enables a dielectric constant of the resin composition to be reduced, so that a build-up material made of the resin composition used in a IC substrate can have a low dielectric property (e.g., a low Df value).

In addition, the content of the inorganic filler material (D) being not less than 40 wt % enables the build-up material made of the resin composition to have better dimensional stability, thereby improving reliability of the IC substrate.

Furthermore, the modified polyphenylene ether resin (C) added in the low-dielectric resin composition can improve adhesion between a metal coating layer and the build-up material, reduce a dielectric loss (Df) value of the build-up material, and increase a glass transition temperature (Tg) of the build-up material.

In some embodiments of the present disclosure, the inorganic filler material (D) can be, for example, spherical silica particles. The spherical silica particles can be formed through a synthetic method (e.g., a sol-gel method), but the present disclosure is not limited thereto.

In some embodiments of the present disclosure, a surface of each of the spherical silica particles is modified with at least one of an epoxy group, an acrylic group, and a vinyl group.

In addition, a silica purity in each of the spherical silica particles is not less than 95 wt %, and is preferably not less than 99 wt %.

In some embodiments of the present disclosure, an average particle diameter D50 of the spherical silica particles ranges from 0.05 micrometers to 5 micrometers, and preferably ranges from 0.1 micrometers to 2 micrometers. Further, a specific surface area of each of the spherical silica particles ranges from 1 m²/g to 10 m²/g, and preferably ranges from 4 m²/g to 6 m²/g.

According to the above configuration, the inorganic filler material can be evenly dispersed in the resin composition including the epoxy resin, and can help in increasing the dimensional stability of the build-up material made of the resin composition.

The low-dielectric resin composition further includes a siloxane coupling agent (E), an accelerant (F), and a peroxide (G). The components (E) to (G) are all non-volatile components, but the present disclosure is not limited thereto.

Furthermore, based on the total weight of the low-dielectric resin composition being 100 wt %, a content of the siloxane coupling agent (E) ranges from 0.01 wt % to 5 wt %, a content of the accelerant (F) ranges from 0.01 wt % to 5 wt %, and a content of the peroxide (G) ranges from 0.005 wt % to 3 wt %, but the present disclosure is not limited thereto.

The siloxane coupling agent (E) can assist in improving compatibility and cross-linking degree between the epoxy resin and the inorganic filler material.

The accelerant (F) can control a reaction of the resin composition to be reacted completely, and can assist in improving uniformity of a film surface of the build-up material made of the resin composition.

In one embodiment of the present disclosure, the accelerant is an amine-based hardening accelerant. For example, the accelerant is 4-dimethylaminopyridine (DMAP).

Furthermore, the peroxide (G) can interact with the modified polyphenylene ether resin (C), so as to promote a reaction rate of the resin composition.

A resin made of the low-dielectric resin composition has a dielectric constant (Dk) ranging from 3.0 to 3.3 and a dissipation factor (i.e., dielectric loss Df) of not greater than 0.0045 (preferably between 0.0025 and 0.0030) under a signal of 10 GHz, but the present disclosure is not limited thereto.

In terms of processing method, the low-dielectric resin composition can be, for example, formed into a coating material that is in a fluid state (e.g., a varnish) through dissolution and dispersion of a solvent.

The coating material formed of the low-dielectric resin composition can be coated on a support substrate through a coater. Then, the coating material can be dried at a high temperature to remove the solvent, so that the coating material can be formed into a low-dielectric resin coating layer (i.e., the resin made of the low-dielectric resin composition) on the support substrate, which can be used as a build-up material for the IC substrate.

A weight ratio between the low-dielectric resin composition (i.e., the non-volatile components) and the solvent (i.e., the volatile components) is between 50:50 and 70:30.

In addition, in one embodiment of the present disclosure, the solvent can be, for example, a co-solvent. The co-solvent is composed of toluene and butanone, which are mixed in a volume ratio of 70:30 to 90:10, but the present disclosure is not limited thereto.

A thickness of the low-dielectric resin coating layer (i.e., the build-up material of the IC substrate) can be, for example, between 20 micrometers and 60 micrometers, and preferably between 30 micrometers and 50 micrometers.

Furthermore, an arithmetic mean roughness Ra of a surface of the low-dielectric resin coating layer can be, for example, between 50 nanometers and 150 nanometers, which can facilitate the production of extremely fine lines.

The material types in which the component (A) to the component (G) can be implemented are listed below, but the present disclosure is not limited thereto.

In some embodiments of the present disclosure, the epoxy resin (A) can be, for example but not limited to, an epoxy resin produced by Dainippon Ink and Chemicals, Incorporated (abbreviated as DIC) under the model of HP-4710, HP-4700, HP-6000, HP-7200, or N-695; an epoxy resin produced by Nippon Kayaku Co., Ltd. under the model of NC7000L, NC3000, or NC3500; an epoxy resin produced by Nippon Steel Chemical Co., Ltd. under the model of ESN475V or ESN485; an epoxy resin produced by Mitsubishi Chemical Corporation under the model of YX4000 or YL7760; or an epoxy resin produced by Nan Ya Plastics Corporation under the model of NPES-903, NPEL-128E, or NPEL-170.

The epoxy resin can be, for example, one or more of the aforementioned materials.

In a specific embodiment of the present disclosure, the epoxy resin is a mixed resin that includes HP-6000 (naphthol-novolac epoxy resin) and NPEL-170 (bisphenol F-type epoxy resin), which are mixed with each other in a weight ratio of 1:2 to 2:1 (preferably 1:1), thereby controlling the surface roughness of the material (i.e., the arithmetic mean roughness Ra of the surface of the low-dielectric resin coating layer).

In some embodiments of the present disclosure, the active ester compound (B) can be, for example, but not limited to, a reactive polyester resin produced by Dainippon Ink and Chemicals, Incorporated (abbreviated as DIC) under the model of HPC-8000 or HPC-8150.

In a specific embodiment of the present disclosure, the active ester compound has a naphthalene structure, such as: HPC-8150, but the present disclosure is not limited thereto.

In some embodiments of the present disclosure, the modified polyphenylene ether resin (C) can be, for example, selected from the group consisting of: a vinyl benzyl-containing polyphenylene ether resin (e.g., OPE-2st, available from Mitsubishi Gas Chemical Company), a methacrylate-containing polyphenylene ether resin (e.g., SA9000, available from Sabic; EU910, available from Nan Ya Plastics Corporation), a vinyl benzyl-containing bisphenol A polyphenylene ether resin, and a chain-extended vinyl-containing polyphenylene ether resin.

Alternatively, the component (C) can also be, for example, an acrylic resin, which can be selected from the group consisting of: a methacrylate-containing polyphenylene ether resin (e.g., SA9000, available from Sabic), a dioxolane diol diacrylate resin (e.g., A-DOG, available from Shinkamura Chemical Co., Ltd.), and a tricyclodecane dimethanol diacrylate resin (e.g., DCP-A, available from Kyoeisha Chemical Co., Ltd).

In a specific embodiment of the present disclosure, the modified polyphenylene ether resin is SA9000, which is a polyphenylene ether resin having a number average molecular weight (Mn) of about 1,900 g/mol to 2,300 g/mol, and a terminal end of the polyphenylene ether resin is modified with dimethacrylate, but the present disclosure is not limited thereto.

In some embodiments of the present disclosure, the inorganic filler material (D) is spherical silica particles, and a surface of each of the spherical silica particles is modified with epoxy groups.

In a specific embodiment, the inorganic filler material is at least one of EQH 1003-SES spherical silica particles and EQH 1003-SMS spherical silica particles available from Third Age Technology (TAT).

In some embodiments of the present disclosure, the siloxane coupling agent (E) is at least one of Z6030 siloxane coupling agent, Momentive A-187S siloxane coupling agent (i.e., the silane containing epoxy functional group), and 3-methacryloxypropyltrimethoxysilane produced by Dow Toray Co., Ltd.

Preferably, the siloxane coupling agent is Z6030 siloxane coupling agent or A-187S siloxane coupling agent, but the present disclosure is not limited thereto.

In some embodiments of the present disclosure, the accelerant (F) is preferably an amine-based hardening accelerant. The amine-based hardening accelerant is selected from the group consisting of: triethylamine, tributylamine, 4-dimethylaminopyridine (DMAP), 2,4,6-tris(dimethylaminomethyl)phenol, 1,8-diazabicyclo[5.4.0]undec-7-ene (DBU), and 1,5-diazabicyclo[4.3.0]non-5-ene (DBN).

In a specific embodiment of the present disclosure, the accelerant is 4-dimethylaminopyridine (DMAP), but the present disclosure is not limited thereto.

For example, in some other embodiments of the present disclosure, the accelerant can be at least one of 2-ethyl-4-methyl imidazole (2E4MZ) and tetraphenylphosphonium tetra-p-triborate (TPP-MK).

In some embodiments of the present disclosure, the peroxide (G) is selected from the group consisting of: benzyl peroxide, p-chlorobenzoyl peroxide, di(tertiary butyl) peroxide, diisopropyl peroxycarbonate, and di-2-ethylhexyl peroxycarbonate.

In a specific embodiment of the present disclosure, the peroxide is Perbutyl P, which is available from Nisshin OilliO Group, Ltd.

According to the above configuration, the low-dielectric resin composition provided by the embodiment of the present disclosure can be suitable for preparing a build-up material in an IC substrate, and has a low dielectric constant, which is beneficial to the application of high-frequency and high-speed transmission.

The low-dielectric resin composition provided by the embodiment of the present disclosure can be used for forming an insulating layer of a printed circuit board. The printed circuit board can be manufactured by a process that involves a resin sheet material that uses the insulating layer made of the low-dielectric resin composition to bond with an inner layer substrate.

The inner layer substrate refers to a component that becomes the substrate of the printed circuit board and can be, for example, a glass epoxy substrate, a metal substrate, a polyester substrate, a polyimide substrate, a bismaleimide triazine (BT) resin substrate, or a thermosetting polyphenylene ether substrate. Additionally, the substrate can be covered by a conductor layer on one side surface or both side surfaces thereof, which can be pattern processed.

The lamination of the inner layer substrate with the resin sheet material (i.e., the insulating layer) can be performed by heating and pressing the resin sheet material onto the inner layer substrate from a side of the support body. Components that can be used to heat and press the resin sheet material onto the inner layer substrate include, for example, a heated metal plate (e.g., a stainless steel end plate) or a metal roller (e.g., a stainless steel roller). The heated and pressed component is pressed against the resin sheet material, or is pressed through an elastic material (e.g., a heat-resistant rubber), so as to ensure that the resin sheet material conforms to the surface irregularities of the inner layer substrate. The lamination of the inner layer substrate with the resin sheet material can be carried out using a vacuum lamination process. In the vacuum lamination process, a hot pressing temperature ranges from 80° C. to 140° C., a hot pressing pressure ranges from 0.05 MPa to 1.5 MPa, and a hot pressing time ranges from 20 seconds to 300 seconds.

The resin sheet material (i.e., the insulating layer) is hardened to form a solidified product composed of the resin composition. The thermal hardening conditions for the resin sheet material vary depending on the resin composition. A hardening temperature is preferably between 120° C. and 240° C.

### Experimental Data and Test Results

The present disclosure will be described in detail below with reference to Exemplary Examples 1 to 6 and Comparative Examples 1 to 2. However, the following examples are only used to help understand the present disclosure, and the scope of the present disclosure is not limited to the following examples.

Exemplary Example 1: A resin composition is prepared. The resin composition includes an epoxy resin (A) (including 8.1 parts by weight of HP 6000 and 8.1 parts by weight of NPEL-170), an active ester compound (B) (including 16.7 parts by weight of HPC-8150), a modified polyphenylene ether resin (C) (including 0.3 parts by weight of SA9000), an inorganic filler material (D) (including 100 parts by weight of EQH1003-SES), a siloxane coupling agent (E) (including 0.2 parts by weight of A-187S), an accelerant (F) (including 0.1 parts by weight of DMAP), and a peroxide (G) (including 0.05 parts by weight of Perbutyl P). A total amount of the components (A) to (G) is 133.55 parts by weight. Herein, a content of the inorganic filler material (D) in the resin composition is 74.8 wt % (i.e., 100/133.55), and the ratio of the content of the active ester compound (B) divided by the content of the epoxy resin (A) is 1.03 (i.e., 16.7/(8.1+8.1)).

Then, the resin composition is dissolved and dispersed in a solvent to form a varnish-like coating material. The coating material is coated on a support body using a coater. The support body can be a plastic film or a metal foil. In Exemplary Example 1, the support body is a plastic film. The material of the plastic film can be selected from the group consisting of polyethylene terephthalate (PET), polyethylene naphthalate (PEN), polycarbonate (PC), and polymethyl methacrylate (PMMA). In Exemplary Example 1, the material of the plastic film is polyethylene terephthalate (PET). The coating material is then dried at a high temperature in an oven to remove the solvent, thereby forming a dried resin coating layer on the support body.

A weight ratio between the resin composition (i.e., the non-volatile components) and the solvent (i.e., the volatile components) is 70:30. The solvent is a co-solvent composed of toluene and butanone, which are mixed in a volume ratio of 90:10. Additionally, the dried resin coating layer has a thickness of about 40 micrometers.

The preparation methods of Exemplary Examples 2 to 6 are substantially the same as that of Exemplary Example 1, except for the selection and proportion of materials.

The preparation methods of Comparative Examples 1 to 2 are substantially the same as that of Exemplary Example 1. The difference lies in the selection and proportion of materials. In addition, Comparative Examples 1 to 2 use hardening agent (C′) (i.e., bisphenol-A, BPA), but do not use the modified polyphenylene ether resin (C) and the peroxide (G). The preparation conditions and test results of the above-mentioned Exemplary Examples 1 to 6 and Comparative Examples 1 to 2 are summarized in Table 1 and Table 2, respectively.

Then, the dried resin coating layer made of the resin composition prepared in each of Exemplary Examples 1 to 6 and Comparative Examples 1 to 2 is heated at 200° C. for 90 minutes to obtain a hardened resin coating layer, and then the support body is peeled from the hardened resin coating layer. Finally, the hardened resin coating layer is tested so as to obtain relevant test results. The relevant test methods are described as follows.

Glass transition temperature Tg (° C.) of the material is determined by using a thermomechanical analyzer (TMA) in accordance with the standard test method ASTM E1545.

Coefficient of Thermal Expansion (CTE) (ppm/° C.) for a X-Y plane of the material (i.e., X-Y CTE) is determined by using a thermomechanical analyzer (TMA) in accordance with the standard test method IPC-TM-650 2.4.24. The range of heating conditions is between 25° C. and 150° C.

Dk (dielectric constant) and Df (dissipation factor) are determined according to the standard test method IPC-TM-650 (Method 2.5.5.3), where a material sample is placed in a fixture for testing. This method measures a dielectric constant (Dk, εr) and a dissipation factor (Df, Tan δ, also called loss factor) of the material under a signal of 10 GHz.

Arithmetic Mean Roughness (Ra) (nm) is measured by using an atomic force microscope (AFM) in accordance with the standard test method JIS B 0601-2001.

Determination of whether varnish exhibits phase separation is made by observing, with the naked eye, whether the coating material in a fluid state (i.e., the varnish), formed by the resin composition and solvents (toluene and butanone), shows any signs of phase separation after being left undisturbed for 24 hours.

Determination of whether a coating surface of the coating layer is smooth is made by visually inspecting a surface appearance of the coating layer formed after the coating material is dried (solvent removed) to assess whether the coating surface is flat.

TABLE 1

| | | Exemplary Examples | | | | | |
|---|---|---|---|---|---|---|---|
| Items | | 1 | 2 | 3 | 4 | 5 | 6 |
| Resin | (A) Epoxy resin | | | | | | |
| composition | HP6000 | 8.1 | 7.4 | 6.5 | 6.5 | 6.5 | 6.5 |
| | (parts by weight) | | | | | | |
| | NPEL-170 | 8.1 | 7.4 | 6.5 | 6.5 | 6.5 | 6.5 |
| | (parts by weight) | | | | | | |
| | (B) Active ester compound | | | | | | |
| | HPC-8150 | 16.7 | 14 | 19.8 | 19.8 | 19.8 | 19.8 |
| | (parts by weight) | | | | | | |
| | (C) Modified polyphenylene | | | | | | |
| | ether resin | | | | | | |
| | SA9000 | 0.3 | 0.4 | 0.42 | 0.42 | 0.42 | 0.42 |
| | (parts by weight) | | | | | | |
| | (D) Inorganic filler material | | | | | | |
| | EQH1003-SES | 100 | 100 | 100 | 100 | 100 | |
| | (parts by weight) | | | | | | |
| | EQH1003-SMS | | | | | | 100 |
| | (parts by weight) | | | | | | |
| | (E) Siloxane coupling agent | | | | | | |
| | A-187S | 0.2 | 0.2 | 0.2 | 0.2 | 0.2 | |
| | (parts by weight) | | | | | | |
| | Z6030 | | | | | | 0.2 |
| | (parts by weight) | | | | | | |
| | (F) Accelerant | | | | | | |
| | 2E4MZ | | | | | 0.1 | |
| | (parts by weight) | | | | | | |
| | TPP-MK | | | | 0.1 | | |
| | (parts by weight) | | | | | | |
| | DMAP | 0.1 | 0.1 | 0.1 | | | 0.1 |
| | (parts by weight) | | | | | | |
| | (G) Peroxide | | | | | | |
| | Perbutyl P | 0.05 | 0.05 | 0.05 | 0.05 | 0.05 | 0.05 |
| | (parts by weight) | | | | | | |
| Test | Tg(TMA)(° C.) | 161 | 162 | 164 | 163 | N.A. | 164 |
| Results | X-YCTE(TMA) | 13.10 | 13.24 | 12.93 | 13.22 | N.A. | 12.74 |
| | 25 to 150° C. (ppm/° C.) | | | | | | |
| | Dk/Df(10 GHz) | 33/ | 3.3/ | 3.3/ | 3.3/ | N.A. | 3.3/ |
| | | 0.00402 | 0.0038 | 0.0027 | 0.0027 | | 0.0027 |
| | Ra(nm) | 50 | 50 | 50 | 50 | N.A. | 50 |
| | Determination of | No phase | No phase | No phase | No phase | phase | No phase |
| | whether varnish exhibits | separation | separation | separation | separation | separation | separation |
| | phase separation | | | | | | |
| | Determination of | Smooth | Smooth | Smooth | Not | Film is | Smooth |
| | whether coating surface of | | | | smooth | not | |
| | coating layer is smooth | | | | | formed. | |

TABLE 2

| | | Comparative Examples | |
|---|---|---|---|
| Items | | 1 | 2 |
| Resin | (A) Epoxy resin | | |
| composition | HP6000 | 8.1 | 9.6 |
| | (parts by weight) | | |
| | NPEL-170 | 8.1 | 9.6 |
| | (parts by weight) | | |
| | (B) Active ester compound | | |
| | HPC-8150 | 16.7 | 6.37 |
| | (parts by weight) | | |
| | (C') Hardening agent | | |
| | Bisphenol-A | 0.4 | 7.61 |
| | (parts by weight) | | |
| | (D) Inorganic filler | | |
| | EQH1003-SES | 100 | 100 |
| | (parts by weight) | | |
| | (E) Siloxane coupling | | |
| | agent | | |
| | A-187S | 0.2 | 0.2 |
| | (parts by weight) | | |
| | (F) Accelerant | | |
| | DMAP | 0.1 | 0.1 |
| | (parts by weight) | | |
| | (G) Peroxide | — | — |
| Test | Tg(TMA)(° C.) | 157 | 163 |
| Results | X-YCTE(TMA) | 14.99 | 15.2 |
| | 25 to 150° C.(ppm/° C.) | | |
| | Dk/Df(10 GHz) | 3.4/0.0046 | 3.5/0.0072 |
| | Ra(nm) | 50 | 50 |
| | Determination of | No phase | No phase |
| | whether varnish exhibits | separation | separation |
| | phase separation | | |
| | Determination of | Smooth | Smooth |
| | whether coating surface of | | |
| | coating layer is smooth | | |

The test results of Table 1 and Table 2 show that, in each of Exemplary Examples 1 to 3 and 6, the ratio of the content of the active ester compound (B) relative to the content of the epoxy resin (A) (i.e., the ratio of B/A) falls within the range of 0.8 to 1.5. This ratio helps to reduce the dielectric constant (Dk) of the resin composition. Additionally, the content of the inorganic filler material (C) in each of Exemplary Examples 1 to 3 and 6 falls within the range of 60 wt % to 90 wt %, which contributes to enhancing the dimensional stability of the material. The coating layer prepared in each of Exemplary Examples 1 to 3 and 6 exhibits a dissipation factor (Df) of not greater than 0.0041 under a signal of 10 GHz, which indicates good dielectric properties.

It is also worth mentioning that, in each of Exemplary Examples 1 to 3 and 6, the accelerant (F) adopts an amine-based hardening accelerant (DMAP), which improves reactivity and assists in enhancing the uniformity of the film surface. However, in Exemplary Example 4, the accelerant adopts TPP-MK, which shows poor reactivity and results in an uneven film surface. In Exemplary Example 5, the accelerant adopts 2E4MZ, which has poor compatibility with the resin composition, leading to phase separation. Moreover, the coating material in Exemplary Example 5 cannot be formed into a coating film, so that the related tests are not available.

Although the coating layers prepared in Comparative Examples 1 and 2 do not have problems with phase separation or uneven film surface appearance, the dissipation factors (Df) of the coating layers in Comparative Examples 1 and 2 are both greater than 0.0045 under the signal of 10 GHZ, which indicates poor dielectric properties.

It should be noted that patent applications involving compositions typically use two methods of representation, namely “parts by weight (PHR)” and “weight percentage (wt %).” The “parts by weight (PHR)” notation reflects the proportional relationship between the components, so that there is no need to fulfill the constraints of the “weight percentage (wt %)” notation, which requires adherence to two “upper and lower limit formulas” and the sum of the percentages in the examples to equal 100 wt %. The two “upper and lower limit formulas” are as follows: the upper limit value of the content of a single component plus the lower limit values of the contents of the remaining components must be less than or equal to 100 wt %; or, the lower limit value of the content of a single component plus the upper limit values of the contents of the remaining components must be greater than or equal to 100 wt %. If the usage of “parts by weight” is converted to “weight percentage”, it implies that a percentage benchmark, i.e., a total amount benchmark, and thus must follow the upper and lower limit rules. An example of conversion is as follows: For a composition including 50 parts by weight of A and 30 parts by weight of B, after conversion, it becomes a compound comprising 50/(50+30) wt % of A, and 30/(50+30) wt % of B.

### Beneficial Effects of the Embodiments

In conclusion, in the low-dielectric resin composition provided by the present disclosure, by virtue of “the resin composition including an epoxy resin, an active ester compound, a modified polyphenylene ether resin, and an inorganic filler material,” and “based on a total weight of the low-dielectric resin composition being 100 wt %, a content of the epoxy resin ranging from 5 wt % to 30 wt %, a content of the active ester compound ranging from 5 wt % to 40 wt %, a content of the modified polyphenylene ether resin ranging from 0.1 wt % to 20 wt %, and a content of the inorganic filler material being not less than 40 wt %,” and “a ratio of the content of the active ester compound relative to the content of the epoxy resin ranging from 0.5 to 2,” a resin made of the resin composition can have good dielectric properties (e.g., a Df value of not greater than 0.0045) and dimensional stability, which is beneficial to the applications of high-frequency and high-speed transmission.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A low-dielectric resin composition, comprising:
an epoxy resin;
an active ester compound;
a modified polyphenylene ether resin; and
an inorganic filler material;
wherein, based on a total weight of the low-dielectric resin composition being 100 wt %, a content of the epoxy resin ranges from 5 wt % to 30 wt %, a content of the active ester compound ranges from 5 wt % to 40 wt %, a content of the modified polyphenylene ether resin ranges from 0.1 wt % to 20 wt %, and a content of the inorganic filler material is not less than 40 wt %;
wherein a ratio of the content of the active ester compound relative to the content of the epoxy resin ranges from 0.5 to 2.

2. The low-dielectric resin composition according to claim 1, wherein the ratio of the content of the active ester compound relative to the content of the epoxy resin ranges from 0.65 to 1.8.

3. The low-dielectric resin composition according to claim 1, wherein the inorganic filler material is spherical silica particles.

4. The low-dielectric resin composition according to claim 3, wherein a surface of each of the spherical silica particles is modified with at least one of an epoxy group, an acrylic group, and a vinyl group, and a silica purity in each of the spherical silica particles is not less than 95 wt %; wherein an average particle diameter D50 of the spherical silica particles ranges from 0.05 micrometers to 5 micrometers, and a specific surface area of each of the spherical silica particles ranges from 1 m²/g to 10 m²/g.

5. The low-dielectric resin composition according to claim 1, further comprising:
a siloxane coupling agent;
an accelerant; and
a peroxide;
wherein, based on the total weight of the low-dielectric resin composition being 100 wt %, a content of the siloxane coupling agent ranges from 0.01 wt % to 5 wt %, a content of the accelerant ranges from 0.01 wt % to 5 wt %, and a content of the peroxide ranges from 0.005 wt % to 3 wt %.

6. The low-dielectric resin composition according to claim 5, wherein the accelerant is an amine-based hardening accelerant.

7. The low-dielectric resin composition according to claim 6, wherein the accelerant is selected from the group consisting of triethylamine, tributylamine, 4-dimethylaminopyridine (DMAP), 2,4,6-tris(dimethyl aminomethyl) phenol, 1,8-diazabicyclo[5.4.0]undec-7-ene (DBU), and 1,5-diazabicyclo[4.3.0]non-5-ene (DBN).

8. The low-dielectric resin composition according to claim 1, wherein the epoxy resin is a mixed resin that includes a naphthol-novolac epoxy resin and a bisphenol F-type epoxy resin, and the naphthol-novolac epoxy resin and the bisphenol F-type epoxy resin are mixed with each other in a weight ratio of 1:2 to 2:1; wherein the active ester compound has a naphthalene structure.

9. The low-dielectric resin composition according to claim 1, wherein the modified polyphenylene ether resin is selected from the group consisting of a vinyl benzyl-containing polyphenylene ether resin, a methacrylate-containing polyphenylene ether resin, a vinyl benzyl-containing bisphenol A polyphenylene ether resin, and a chain-extended vinyl-containing polyphenylene ether resin.

10. The low-dielectric resin composition according to claim 1, wherein a resin made of the low-dielectric resin composition has a dielectric constant (Dk) ranging from 3.0 to 3.3 and a dissipation factor (Df) of not greater than 0.0045 under a signal of 10 GHz.

11. A low-dielectric resin composition, comprising:
an epoxy resin;
an active ester compound;
an acrylic resin; and
an inorganic filler material;
wherein, based on a total weight of the low-dielectric resin composition being 100 wt %, a content of the epoxy resin ranges from 5 wt % to 30 wt %, a content of the active ester compound ranges from 5 wt % to 40 wt %, a content of the acrylic resin ranges from 0.1 wt % to 20 wt %, and a content of the inorganic filler material is not less than 40 wt %;
wherein a ratio of the content of the active ester compound relative to the content of the epoxy resin ranges from 0.5 to 2.

12. The low-dielectric resin composition according to claim 11, wherein the acrylic resin is selected from the group consisting of a methacrylate-containing polyphenylene ether resin, a dioxolane diol diacrylate resin, and a tricyclodecane dimethanol diacrylate resin.
